(19) United States
(12) Patent Application Publication
(10) Pub. No.: US 2026/0176136 A1
(43) Pub. Date: Jun. 25, 2026

(54) CONVERSION OF H2 AND OFF-GAS CONTAINING CO2 TO SYNFUELS

(71) Applicant: TOPSOE A/S, Kgs. Lyngby (DK)

(72) Inventors: Thomas Sandahl CHRISTENSEN, Kgs. Lyngby (DK); Sudip DE SARKAR, Kokkedal (DK)

(73) Assignee: TOPSOE A/S, Kgs. Lyngby (DK)

(21) Appl. No.: 19/124,012

(22) PCT Filed: Nov. 20, 2023
(86) PCT No.: PCT/EP2023/082373

§ 371 Date: Apr. 24, 2025

(30) Foreign Application Priority Data
Nov. 21, 2022 (EP) 222208570.6

(51) Int. Cl. C01B 3/48; C01B 3/34; C01B 3/36; C01B 3/382; C01B 3/384

(52) U.S. Cl. CPC C01B 3/48; C01B 3/34; C01B 3/36; C01B 3/382; C01B 3/384; C01B 2203/0244; C01B 2203/1241

(57) ABSTRACT

A process is provided for producing a hydrocarbon product stream in a hydrocarbon plant. The hydrocarbon plant comprises a reverse water gas shift (RWGS) unit (I), and a second feed comprising carbon dioxide to said reverse water gas shift (RWGS) unit (I). The second feed is a process off-gas containing less than 75% CO₂ and is the sole carbon dioxide-containing feed to said reverse water gas shift (RWGS) unit (I).

### TECHNICAL FIELD

The present invention relates to a process for producing a hydrocarbon product stream in a hydrocarbon plant. The hydrocarbon plant comprises a reverse water gas shift (RWGS) unit (I), and a feed comprising carbon dioxide to said reverse water gas shift (RWGS) unit (I). This feed is a process off-gas containing less than 75% CO₂ and is the sole carbon dioxide-containing feed to said reverse water gas shift (RWGS) unit (I). The process of the present invention provides overall better utilization of carbon dioxide.

### BACKGROUND

Carbon capture and utilization (CCU) has gained more relevance in the light of the rise of atmospheric CO₂ since the Industrial Revolution. In one way of utilizing CO₂, CO₂ and H₂ can be converted to synthesis gas (a gas rich in CO and H₂) which can be converted further to valuable products like alcohols (including methanol), fuels (such as gasoline, jet fuel, kerosene and/or diesel produced for example by the Fischer-Tropsch (F-T) process), and/or olefins etc.

Existing technologies focus primarily on stand-alone reverse Water Gas Shift (RWGS) processes to convert CO₂ and H₂ to synthesis gas. The synthesis gas can subsequently be converted to valuable products in the downstream processes as outlined above. The reverse water gas shift reaction proceeds according to the following reaction:

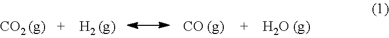

Undesired by-product formation of, for example methane, may take place according to one or both of the methanation reactions:

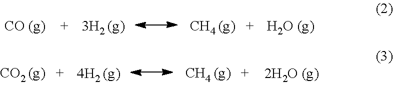

The RWGS reaction (1) is an endothermic process which requires significant energy input for the desired conversion. High temperatures are needed to obtain sufficient conversion of carbon dioxide into carbon monoxide to make the process economically feasible.

Several patent applications have been made in the recent years on process configurations with conversion of H₂ and CO₂ to synfuels. In some situations, however, a CO₂ feed stream with high concentration of CO₂ may not always be available, and alternative solutions may have to be found.

Patent publication WO2021/110806 describe an eRWGS reactor, and patent application PCT/EP2021/078304 describe various process configurations with RWGS and various feed stream configurations.

In the following the wording “selective RWGS” shall mean that only the reverse water gas shift reaction takes place either on a catalyst or in a reactor while “non-selective RWGS” shall mean that other reactions such as one or more of the methanation reactions (including also reverse methanation) takes place in addition to reverse water gas shift.

### SUMMARY

A process for producing a hydrocarbon product stream, in a hydrocarbon plant is provided. The hydrocarbon plant comprises:
a reverse water gas shift (RWGS) unit (I),
a syngas-producing unit (II),
optionally, a first feed comprising hydrogen to said reverse water gas shift (RWGS) unit (I),
a second feed comprising carbon dioxide to said reverse water gas shift (RWGS) unit (I),
a third feed comprising methane to said syngas-producing unit (II),
a Fischer-Tropsch (F-T) section (III),

The process comprises the steps of:
a) optionally supplying said first feed comprising hydrogen to said reverse water gas shift (RWGS) unit (1);
b) supplying said second feed to said reverse water gas shift (RWGS) unit (1);
   wherein said second feed is a process off-gas containing less than 75% CO₂ and is the sole carbon dioxide-containing feed to said reverse water gas shift (RWGS) unit (1);
c) converting said second feed and—where present—said first feed into a first syngas stream in said reverse water gas shift (RWGS) unit (1);
d) supplying said third feed comprising methane to said syngas-producing unit (II) and converting it into a second syngas stream;
e) supplying at least a portion of said first syngas stream and at least a portion of said second syngas stream to said Fischer-Tropsch (F-T) section (III) and converting said portions of said first and second syngas streams into at least a hydrocarbon product stream and an F-T off-gas stream.

Conventional RWGS-based processes typically use high-purity CO₂ containing feedstocks, e.g. feedstocks containing at least more than 95% CO₂ and typically more than 99% CO₂. The present invention is based on the surprising experimental finding that it is possible to operate a RWGS reactor using a low-purity CO₂ containing feedstock with a CO₂ content of as low as e.g. 20-35%. The present invention is further based on the recognition that this fact makes it possible to use an off-gas from a Fischer-Tropsch (F-T) section as CO₂ containing feed to a RWGS reactor, or another low-purity CO₂ containing feedstock. Furthermore, the present invention is based on the surprising finding that it possible to operate a RWGS reactor using an off-gas from a Fischer-Tropsch (F-T) section as the sole CO₂ containing feed.

The process makes effective use of various streams, in particular process off-gas. The technical advantages of the present invention are at least two-fold:
1) process off-gas is typically used as fuel gas, in which case CO₂ is emitted to the atmosphere, which is undesired. This includes CO₂ originating from the process off-gas itself and CO₂ originating from burning of hydrocarbons in the use of off-gas as fuel. These emissions can be reduced, or totally avoided in the present invention.
2) The carbon efficiency of the process is improved, since the carbon contained in the process off-gas is recycled and reused in the process, whereby a higher proportion of carbon supplied to the process is converted into the hydrocarbon product stream.

Furthermore, the process of the invention has provided a possibility of revamping (also known as retrofitting) an existing synfuel-producing process/plant comprising a syngas-producing reactor and an Fisher-Tropsch unit and no RWGS unit by adding a RWGS unit to the process. By such a revamp of an existing process, it is possible to achieve the technical advantages 1) and 2) for the revamped process.

Further details of the technology are provided in the enclosed dependent claims, Figures and examples.

### LEGENDS TO THE FIGURES

The technology is illustrated by means of the following schematic illustrations, in which:

FIG. 1 shows a first layout of the hydrocarbon plant of the invention with various feeds.

FIG. 2 shows a further layout of the hydrocarbon plant of the invention with various feeds, in which the F-T off-gas stream from the F-T section is supplied to the RWGS unit as the second feed.

FIG. 3 shows a variation of FIG. 2, in which the syngas producing unit (II) is an autothermal reforming (ATR) unit (IIa), and in which a portion of the FT off-gas stream from the F-T section is supplied to the RWGS unit (I) as the second feed and a portion of the FT off-gas stream is supplied to the ATR unit (IIa).

### DETAILED DISCLOSURE

Unless otherwise specified, any given percentages for gas content are % by volume. All feeds are preheated as required.

This technology relates to the second feed stream being an off-gas stream which preferably has low to medium content of CO₂ (i.e., below 75% CO₂) and optionally also containing hydrogen and/or hydrocarbons and/or CO.

Carbon capture and utilization has gained more attention over the years. Plant layouts are known which provide a solution for CO₂ utilization in presence of H₂ to produce syngas and subsequently, conversion of such syngas to valuable products, such as syngas derived liquid fuel, also known as synfuels. For conversion of CO₂ and H₂ feeds to syngas, an electrically heated RWGS (e-RWGS) unit is preferably used.

In this context, the term “feed comprising hydrocarbons” is meant to denote a gas with one or more hydrocarbons and possibly other constituents. Thus, typically feed gas comprising hydrocarbons comprises a hydrocarbon gas, such as CH₄ and optionally also higher hydrocarbons often in relatively small amounts, in addition to various amounts of other gasses. Higher hydrocarbons are components with two or more carbon atoms such as ethane and propane. Examples of “hydrocarbon gas” may be natural gas, town gas, naphtha or a mixture of methane and higher hydrocarbons, biogas or LPG. Hydrocarbons may also be components with other atoms than carbon and hydrogen such as oxygenates. The term “feed gas comprising hydrocarbons” is meant to denote a feed gas comprising a hydrocarbon gas with one or more hydrocarbons mixed with steam, hydrogen and possibly other constituents, such as carbon monoxide, carbon dioxide, nitrogen and argon.

The term “synthesis gas” is meant to denote a gas comprising hydrogen, carbon monoxide and also carbon dioxide and small amounts of other gasses, such as argon, nitrogen, methane, etc.

As noted above, the process of the invention takes place in a hydrocarbon plant, said hydrocarbon plant comprising:
a reverse water gas shift (RWGS) unit (I),
a syngas-producing unit (II),
optionally, a first feed comprising hydrogen to said reverse water gas shift (RWGS) unit (I),
a second feed comprising carbon dioxide to said reverse water gas shift (RWGS) unit (I),
a third feed comprising methane to said syngas-producing unit (II),
a Fischer-Tropsch (F-T) section (III).

The process comprising the steps of:
a) optionally supplying said first feed comprising hydrogen to said reverse water gas shift (RWGS) unit (1);
b) supplying said second feed to said reverse water gas shift (RWGS) unit (1); wherein said second feed is a process off-gas containing less than 75% CO₂ and is the sole carbon dioxide-containing feed to said reverse water gas shift (RWGS) unit (1);
c) converting said second feed and—where present—said first feed into a first syngas stream in said reverse water gas shift (RWGS) unit (1);
d) supplying said third feed comprising methane to said syngas-producing unit (II) and converting it into a second syngas stream;
e) supplying at least a portion of said first syngas stream and at least a portion of said second syngas stream to said Fischer-Tropsch (F-T) section (III) and converting said portions of said first and second syngas streams into at least a hydrocarbon product stream and an F-T off-gas stream.

Details of the components which make up the hydrocarbon plant are as follows:

### Reverse Water Gas Shift (RWGS) Unit (I)

Carbon dioxide and—where present—hydrogen feeds are primarily processed in a reverse water gas shift (RWGS) unit, which is preferably an electrically heated reverse water gas shift (e-RWGS) unit.

The first feed comprising hydrogen to the RWGS unit (if present) and the second feed comprising carbon dioxide to the RWGS unit are suitably arranged to be mixed to provide a combined feed which is provided to the RWGS unit.

The RWGS unit (I) is arranged to convert at least a portion of said first feed (comprising hydrogen) and at least a portion of said second feed (comprising CO₂) into a first syngas stream.

The first syngas stream produced in the RWGS unit suitably has the following composition (by volume):
0.5-5% methane (dry)
40-70% H₂ (dry)
10-40% CO (dry)
2-20% CO₂ (dry)

The first syngas stream may additionally contain other components such as steam, and/or nitrogen.

e-RWGS Unit

Preferably, the RWGS unit is an electrically heated reverse water gas shift (e-RWGS) unit. Electrically-heated reverse water gas shift (e-RWGS) uses an electric resistance-heated reactor to perform a more efficient reverse water gas shift process and substantially reduces or preferably avoids the use of fossil fuels as a heat source.

The e-RWGS reactor may either be selective or non-selective. “Selective” means that only the RWGS reaction (reaction 1, above) is carried out. “Non-selective” means that both the RWGS reaction (1) and the methanation reaction (reaction 2 above) are carried out. A non-selective process may also able to perform other reactions such as for example the steam reforming of higher hydrocarbons (hydrocarbons with two or more carbon atoms such as ethane). e-RWGS is described in more detail in, inter alia Angew. Chem. Int. Ed. 2022, 61, e202109696.

An e-RWGS unit is used in the present invention for carrying out the reverse water-gas shift reaction between CO₂ and H₂. The e-RWGS unit suitably comprises:
a structured catalyst arranged for catalysing said RWGS reaction, said structured catalyst comprising a macroscopic structure of electrically conductive material, said macroscopic structure supporting a ceramic coating, wherein said ceramic coating supports a catalytically active material (for selective e-RGWS);
a pressure shell housing said structured catalyst; said pressure shell comprising an inlet for letting in said feed and outlet for letting syngas product; wherein said inlet is positioned so that said feed enters said structured catalyst in a first end of said structured catalyst and said syngas product exits said structured catalyst from a second end of said structured catalyst;
a heat insulation layer between said structured catalyst and said pressure shell; and
at least two conductors electrically connected to said structured catalyst and to an electrical power supply placed outside said pressure shell, wherein said electrical power supply is dimensioned to heat at least part of said structured catalyst to a temperature of at least 500° C. by passing an electrical current through said macroscopic structure of electrically conductive material; wherein said at least two conductors are connected to the structured catalyst at a position on the structured catalyst closer to said first end of said structured catalyst than to said second end of said structured catalyst, and wherein the structured catalyst is constructed to direct an electrical current to run from one conductor substantially to the second end of the structured catalyst and return to a second of said at least two conductors, and wherein the structured catalyst has electrically insulating parts arranged to direct the current from one conductor, which is closer to the first end of the structured catalyst than to the second end, towards the second end of the structured catalyst and back to a second conductor closer to the first end of the structured catalyst than to the second end.

The pressure shell suitably has a design pressure of between 25 and 45 bar. The pressure shell may also have a design pressure of between 30 and 200 bar. The at least two conductors are typically led through the pressure shell in a fitting so that the at least two conductors are electrically insulated from the pressure shell. The pressure shell further comprises one or more inlets close to or in combination with at least one fitting in order to allow a cooling gas to flow over, around, close to, or inside at least one conductor within said pressure shell. The exit temperature of the e-RWGS unit (I) is suitably 900° C. or more, preferably 1000° C. or more.

In case of non-selective e-RWGS, methanation according to reactions (2) and/or (3) takes place in addition to the RWGS reaction. This has the advantage that the concentration of carbon monoxide internally in the reactor is lower than if only reverse water gas shift takes place. This is especially important in the low to moderate temperature range up to ca. 600-800° C. In this temperature range a potential for carbon formation or metal dusting exists or is significantly larger with a selective RWGS catalyst than with a non-selective catalyst.

In one embodiment and when a non-selective catalyst is used in the e-RWGS reactor, the methanation reaction(s) also occur at and near the inlet of the reactor. However, at a given temperature (depends on the feed gas composition, pressure, catalyst activity, extent of heat supply and other factors) the reverse of the methanation reaction will be thermodynamically favoured. In other words, in the first part of the RWGS reactor methane will be formed and in the second part downstream of the first part methane will be consumed according to the reverse of reactions (2) and/or (3).

The combined activity for both reverse water gas shift and methanation in an eRWGS reactor of the invention entails that the reaction scheme inside the reactor will start out as exothermic in the first part of the reactor system but end as endothermic towards the exit of the reactor system. This relates to the heat of reaction (Qᵣ) added or removed during the reaction, according to the general heat balance of the plug flow reactor system:

$$F \cdot {C}_{pm} \cdot dT / dV = {Q}_{add} + {Q}_{r} = {Q}_{add} + Σ ( - {Δ}_{r} {H}_{i} ) \cdot ( - {r}_{i} )$$

where F is the flow rate of process gas, Cₚₘ is the heat capacity, V the volume of the reaction zone, T the temperature, Q_{add} the energy supply/removal from the surrounding, and Qᵣ the energy supply/removal associated with chemical reactions which are given as the sum of all chemical reactions facilitated within the volume and calculated as the product between the reaction enthalpy and the rate of reaction of a given reaction.

A low concentration of methane can be achieved by a high temperature out of the e-RWGS reactor. A high temperature has the further advantage that a higher conversion of CO₂ into CO. In an embodiment the exit temperature of the gas from the e-RWGS reactor is higher 900° C., such than higher than 1000° C. or even higher than 1050° C. It is an advantage of the proposed reactor that a higher temperature can be achieved than what is typically possible with an externally fired reactor.

By use of an e-RWGS unit (as compared to a regular, fired RWGS unit), it is possible to produce a syngas product gas stream with low content of CO₂ (e.g. below 20%) which is desired for some applications, e.g. F-T synthesis or methanol synthesis, since the high temperature of e-RWGS operation ensures a high conversion of CO₂ to CO.

One or more component removal units (to remove e.g. H₂ or CO₂, as needed) may be present downstream the RWGS unit to provide an upgraded first syngas stream.

### Syngas-Producing Unit (II)

The syngas producing unit (II) is arranged to convert at least a portion of a third feed (comprising methane) into a second syngas stream. Additional feeds to the syngas producing unit II (e.g. comprising oxygen and/or steam) may be required.

The syngas producing unit (II) may be selected from the group consisting of an autothermal reforming (ATR) unit (IIa), a steam methane reforming (SMR) unit (IIb) and an electrically heated steam methane reforming (e-SMR) unit (IIc), and is preferably an electrically heated steam methane reforming (e-SMR) unit (IIc).

The second syngas stream may have the following composition (by volume):
40-70% H₂ (dry)
10-30% CO (dry)
2-20% CO₂ (dry)
0.5-5% CH₄ (dry)

In one aspect, the syngas producing unit (II) may be an autothermal reforming (ATR) unit (IIa). The autothermal reforming (ATR) unit converts a third feed comprising methane to a second syngas stream. In one aspect, at least a portion of said F-T off-gas stream from the F-T section (III) is supplied to the syngas-producing unit (II). In this manner, the amount of third feed supplied to the syngas-producing unit (II) can be reduced.

The ATR unit typically comprises a burner, a combustion chamber, and a catalyst bed contained within a refractory lined pressure shell. In an ATR unit, partial combustion of the hydrocarbon containing feed by sub-stoichiometric amounts of oxygen is followed by steam reforming of the partially combusted hydrocarbon feed stream in a fixed bed of steam reforming catalyst. Steam reforming also takes place to some extent in the combustion chamber due to the high temperature. The steam reforming reaction is accompanied by the water gas shift reaction. Typically, the gas is at or close to equilibrium at the outlet of the reactor with respect to steam reforming and water gas shift reactions.

Typically, the (second) syngas stream from the ATR unit has a temperature of 900-1100° C. The (second) syngas stream normally comprises H₂, CO, CO₂, and steam. Other components such as methane, nitrogen, and argon may also be present often in minor amounts. The operating pressure of the ATR unit will be between 5 and 100 bars or more preferably between 15 and 60 bars.

The second syngas stream from the ATR unit is cooled in a cooling train normally comprising a waste heat boiler(s) (WHB) and one or more additional heat exchangers. The cooling medium in the WHB is (boiler feed) water which is evaporated to steam. The second syngas stream is further cooled to below the dew point for example by preheating the utilities and/or partial preheating of one or more feed streams and cooling in air cooler and/or water cooler. Condensed H₂O is taken out as process condensate in a separator to provide a syngas stream with low H₂O content, which can be sent to the Fischer-Tropsch (F-T) section (III). More details of ATR and a full description can be found in the art such as “Studies in Surface Science and Catalysis, Vol. 152,” Synthesis gas production for FT synthesis”; Chapter 4, p. 258-352, 2004”.”.

The “ATR unit” may be a partial oxidation “POX” section. A POX section is similar to an ATR section except for the fact that the ATR unit is replaced by a POX reactor. The POX rector generally comprises a burner and a combustion chamber contained in a refractory lined pressure shell.

The ATR unit could also be a catalytic partial oxidation (cPOX) section.

The oxidant for the autothermal reformer may either be oxygen, air, a mixture of air and oxygen, or be an oxidant comprising more than 80% oxygen such as more than 90% oxygen. The oxidant may also comprise other components such as steam, nitrogen, and/or Argon. Typically, the oxidant in this case will comprise 5-20% steam.

In this aspect, the process further comprises supplying a fourth feed comprising steam and—optionally—a fifth feed comprising oxygen to the autothermal reforming (ATR) unit (IIa). A sixth feed, being a portion of the F-T off-gas stream from the F-T section (III) may also supplied to the syngas-producing unit (II).

A fourth feed comprising steam will be required if the reforming unit is an SMR or an e-SMR.

In another aspect, the syngas-producing unit (II) is an electrically heated steam methane reforming (e-SMR) section (IIc). In this aspect, the plant does not comprise a feed comprising oxygen to the electrically heated steam methane reforming (e-SMR) section (IIc). With this aspect, overall CO₂ output from the plant can be reduced further.

### First Feed

A first feed comprising hydrogen is optionally provided to the RWGS unit. Suitably, the first feed consists essentially of hydrogen. The first feed of hydrogen is suitably “hydrogen rich” meaning that the major portion of this feed is hydrogen; i.e. over 75%, such as over 85%, preferably over 90%, more preferably over 95%, even more preferably over 99% of this feed is hydrogen. One source of the first feed of hydrogen can be one or more electrolyser units. In addition to hydrogen the first feed may for example comprise steam, nitrogen, argon, carbon monoxide, carbon dioxide, and/or hydrocarbons. In some cases, a minor content of oxygen may be present in this feed, typically less than 1000 ppm.

In one aspect, the first feed is absent, and the process off-gas as second feed is the sole carbon dioxide-containing feed to said reverse water gas shift (RWGS) unit (I); and the sole hydrogen-containing feed to said reverse water gas shift (RWGS) unit (I). In other words, the process off-gas can provide essentially all the CO₂ and all the H₂ required for the process.

### Second Feed

A second feed comprising carbon dioxide is provided to the RWGS unit. The second feed is a process off-gas containing less than 75% CO₂ and is the sole carbon dioxide-containing feed to said reverse water gas shift (RWGS) unit (I). This means that CO₂ capture and purification steps can be avoided in the process of the invention.

The second feed may in addition to CO₂ comprise for example hydrogen, steam, nitrogen, oxygenates, amines, ammonia, carbon monoxide, and/or hydrocarbons.

If the first feed is not present, the second feed preferably comprises H₂.

The second feed suitably comprises only low amounts of higher hydrocarbons (i.e. excluding methane), such as for example less than 5% higher hydrocarbons or less than 3% higher hydrocarbons or less than 1% higher hydrocarbons.

The second feed is a process off-gas from a Fischer-Tropsch (F-T) unit, a process off-gas from a methanol loop unit, or a combination of two or more off-gases from two or more such units.

In a particular embodiment, at least a portion (6) of said F-T off-gas stream (32) from the F-T section (III) is supplied to the RWGS unit (I) as at least a portion of the second feed (2). In another embodiment, the process off-gas is a process off-gas from an F-T unit external to the process of the invention.

The methanol loop, from which the process off-gas from a methanol loop unit originates, is external to the process of the invention. The methanol loop, i.e. methanol synthesis section, comprises one or more methanol synthesis reactors. A synthesis gas stream enters the methanol synthesis reactor(s), where it is converted in the presence of a catalyst to a raw product stream comprising methanol. The raw product stream comprising methanol may be cooled in one or more heat exchangers before being fed to a vapor-liquid separator unit, which is typically a High Pressure (HP) separator. The vapor-liquid separator unit provides a product stream comprising methanol and a recycle stream comprising H₂, CO and CO₂, a part of which is purged from the vapor-liquid separator unit as an off-gas stream. The methanol synthesis section may further comprise a hydrogen recovery unit arranged to separate the methanol off-gas stream into a H₂ rich stream containing limited amounts of CO and CO₂ and a hydrogen recovery off-gas. In a particular embodiment, the process off-gas from a methanol loop unit is an off-gas from separator unit of a methanol loop unit or an off-gas from a hydrogen recovery unit of a methanol unit.

In a particular embodiment of the process of the invention, at least a portion (6) of said F-T off-gas stream (32) from the F-T section (III) is supplied to the syngas-producing unit (II).

The process off-gas comprises less than 75%, less than 60%, preferably 5-50%, more preferably 10-40%, and most preferably 20-35% CO₂.

The process off-gas comprises less than 60%, more preferably 10-50%, and most preferably 20-40% H₂.

The process off-gas comprises less than 30%, preferably 1-25%, more preferably 5-25%, and most preferably 10-20% hydrocarbons.

In one particularly preferred aspect, at least a portion of the F-T off-gas stream from the F-T section (III) is supplied to the RWGS unit (I) as at least a portion of the second feed.

The recycle of this off-gas stream as the second feed provides a process which is more self-contained, reducing the number of external feeds/units required.

### Combined Feed

As an alternative to separate first feed and second feed, the plant may comprise a combined feed comprising hydrogen and carbon dioxide to the e-RWGS unit (I). Typically, the hydrogen content of this combined feed is between 40 and 80%, preferably between 50 and 70%.

Typically, the carbon dioxide content of this combined feed is between 15 and 50%, preferably between 20 and 40%. Typically, the carbon monoxide content of this combined feed is between 0 and 10%. Typically, the ratio of hydrogen to carbon dioxide in this combined feed is between 1 and 5, preferably between 2 and 4.

In addition to hydrogen and carbon dioxide, the combined feed may for example comprise steam, nitrogen, argon, carbon monoxide, and/or hydrocarbons. The combined feed suitably comprises only low amounts of hydrocarbon, such as for example less than 5% hydrocarbons or less than 3% hydrocarbons or less than 1% hydrocarbons.

### Third Feed

A third feed comprising methane, is provided to the syngas-producing unit (II). The third feed may additionally comprise other components such as CO₂ and/or CO and/or H₂ and/or steam and/or other components such as nitrogen and/or argon. Suitably, the third feed consists essentially of hydrocarbons or a mixture of hydrocarbons and steam. The third feed of hydrocarbons is suitably “hydrocarbon rich” meaning that the major portion of this feed is hydrocarbons; i.e. over 50%, e.g. over 75%, such as over 85%, preferably over 90%, more preferably over 95%, even more preferably over 99% of this feed is hydrocarbons. The concentration of hydrocarbons in this third feed is determined prior to steam addition (i.e. determined as “dry concentration”).

An example of such third feed can also be a natural gas stream external to the plant. In one aspect, said third feed comprises one or more hydrocarbons selected from methane, ethane, propane or butanes.

In one aspect, the third feed comprising methane comprises at least 20, preferably at least 30, preferably at least 40, preferably at least 50, preferably at least 60, preferably at least 70, preferably at least 80, and most preferably at least 90% methane.

The source of the third stream comprising hydrocarbons is preferably external to the plant. The significance of a stream “external to the plant” is that the origin of the stream is not a recycle stream (or a recycle stream further processed or converted) from any synthesis stage in the plant. Possible sources of a third feed comprising hydrocarbons include natural gas, LPG, refinery off-gas, naphtha, and renewables, but other options are also conceivable.

### Fischer-Tropsch (F-T) Section (III)

At least a portion of the first syngas stream and at least a portion of the second syngas stream is supplied to a Fischer-Tropsch (F-T) section (III) and converted into at least a hydrocarbon product stream and an F-T off-gas stream. Suitably, at least a portion of said first syngas stream is combined with at least a portion of said second syngas stream, and the resulting combined syngas stream is suppled to said Fischer-Tropsch (F-T) section (III).

Fischer-Tropsch technology is well-established, and typically provides hydrocarbon product stream in the form of fuels (such as gasoline, jet fuel, kerosene and/or diesel). The output of the F-T section (III) is long chain hydrocarbons, such as wax. These hydrocarbons are converted to fuels such as kerosene, naphtha and/or diesel in the hydrocracking unit downstream the FT section (III).

Suitably, the combined syngas stream at the inlet of said Fischer-Tropsch (F-T) section (III) has a hydrogen/carbon monoxide ratio in the range 1.00-4.00; preferably 1.50-3.00, more preferably 1.90-2.10.

The F-T off-gas stream suitably has a composition corresponding to that given for the second feed above.

### Specific Embodiments

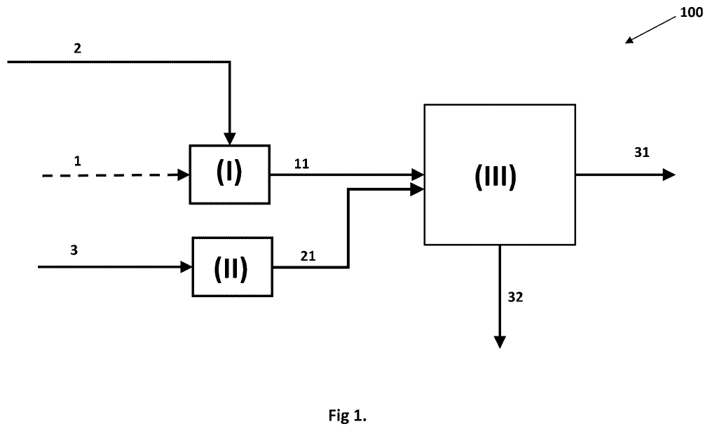

FIG. 1 shows a first layout of the plant used in the process of the invention. The plant 100 comprises
reverse water gas shift (RWGS) unit (I),
syngas-producing unit (II),
Fischer-Tropsch (F-T) section (III),

Plant feeds in FIG. 1 are as follows:
a first feed 1 (optional) comprising hydrogen to said reverse water gas shift (RWGS) unit (I),
a second feed 2 comprising carbon dioxide to said reverse water gas shift (RWGS) unit (I), being a process off-gas containing less than 75% CO₂ as specified, and also being the sole carbon dioxide-containing feed to the reverse water gas shift (RWGS) unit (I);
a third feed 3 comprising methane to said syngas-producing unit (II), In FIG. 1, the first feed 1 comprising hydrogen, and the second feed (2) comprising carbon dioxide, are supplied to the RWGS unit (I), which converts them to a first syngas stream 11 and feeds said first syngas stream 11 to the F-T section III.

In parallel, the third feed 3 comprising methane is fed to the syngas-producing unit (II) and converted into a second syngas stream 21.

The F-T section III receives at least a portion of the first syngas stream 11 and at least a portion of the second syngas stream 21 and converts them into at least a hydrocarbon product stream 31 and an F-T off-gas stream 32.

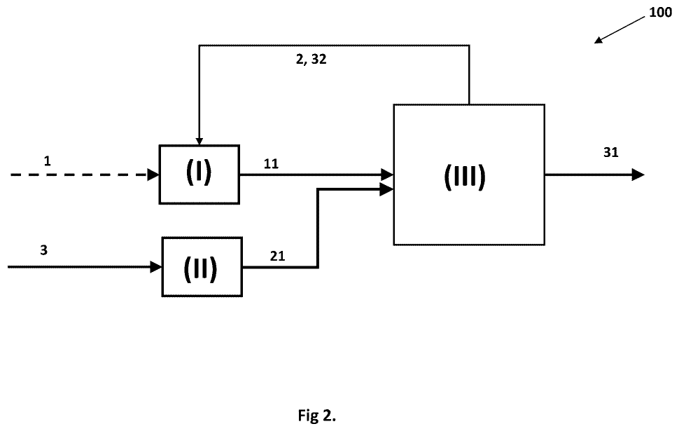

FIG. 2 shows another layout used in the process of the invention. Components and streams in FIG. 2 correspond to those in FIG. 1. As illustrated, the F-T off-gas stream 32 from the F-T section (III) in FIG. 2 is supplied to the RWGS unit (I) as the second feed 2.

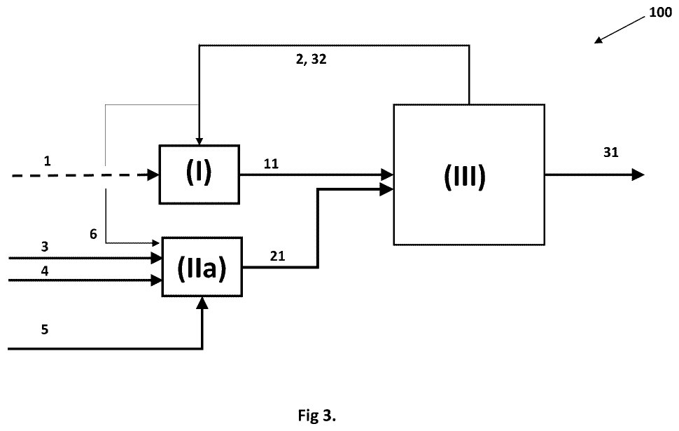

FIG. 3 shows a variation of FIG. 2, in which the syngas producing unit (II) is an autothermal reforming (ATR) unit (IIa), and wherein a fourth feed 4 comprising steam and a fifth feed 5 comprising oxygen is supplied to the autothermal reforming (ATR) unit (IIa). In this layout, at least a portion 6 of the F-T off-gas stream 32 from the F-T section (III) is supplied to the ATR unit (IIa).

The present invention has been described with reference to a number of embodiments and figures. However, the skilled person is able to select and combine various embodiments within the scope of the invention, which is defined by the appended claims. All documents referenced herein are incorporated by reference.

### Example

The Example provides process parameters for three examples C1-C3 of a process comprising syngas production using a RWGS unit and a syngas producing unit and an FT unit. Table 1 shows process parameters, including flow rates and compositions for various feeds to the process for C1-C3 as well as for the syngas product.

TABLE 1

| | | | |
|---|---|---|---|
| Parameters | C1 | C2 | C3 |

Third feed (3) to syngas-producing unit (II)

| | | | | |
|---|---|---|---|---|
| Relative flow | % | 100 | 100 | 100 |
| CH₄ content | mol % | 99.5 | 99.5 | 99.5 |
| N₂ content | mol % | 0.5 | 0.5 | 0.5 |

Fifth feed (5) to syngas-producing unit (II)

| | | | | |
|---|---|---|---|---|
| Relative flow | % | 100 | 103 | 100 |
| O₂ content | mol % | 99.5 | 99.5 | 99.5 |
| Inert (N₂ + Ar) content | mol % | 0.5 | 0.5 | 0.5 |
| Relative flow of H2 | % | 0 | 100 | 50 |

Off-gas from FT- section (III)

| CO₂ content | mol % | 35-45 | | |
|---|---|---|---|---|
| Relative flow as off-gas to syngas- | % | 100 | 134 | 100 |
| producing unit (II) | | | | |

Split of FT off-gas

| | | | | |
|---|---|---|---|---|
| Relative flow to syngas-producing | % | 87 | 100 | 79 |
| unit (II) | | | | |
| Relative flow to RWGS unit (I) | % | 0 | 0 | 21 |
| Other use | % | 13 | 0 | 0 |

Fourth feed (4) comprising steam

| | | | | |
|---|---|---|---|---|
| To syngas-producing unit (II) | % | 100 | 100 | 83 |
| To RWGS unit (I) | % | 0 | 0 | 17 |
| Relative flow steam | % | 100 | 106 | 121 |

Syngas product

| | | | | |
|---|---|---|---|---|
| (H₂ + CO) flow | % | 100 | 105 | 105 |
| H₂/CO | mol/mol | 2.00 | 2.00 | 2.00 |
| RWGS unit is present | | NO | NO | YES |
| in the process | | | | |

The composition of the recycled off-gas from the F-T has the composition shown in Table 2.

TABLE 2

| Component | UoM | Value |
|---|---|---|
| Hydrogen | mol % | 18.0-25.0 |
| Carbon monoxide | mol % | 15.0-20.0 |
| Carbon dioxide | mol % | 35.0-45.0 |
| Methane | mol % | 10.0-18.0 |
| Water | mol % | <1.0 |
| HHC | mol % | <2.0 |
| Inert | mol % | 2.0-5.0 |

### C1

C1 relates to an existing gas-to-hydrocarbon liquid plant layout based on a third feed (3) comprising methane being processed in a syngas-producing unit (II) comprising autothermal reformer(s) to produce syngas of suitable quality for downstream Fischer-Tropsch (F-T) synthesis (III). The off-gas generated in the FT-section (III) is partially utilized in the syngas-producing unit (II) to produce syngas of desired quality (i.e. a H₂/CO ratio). However, often the amount of off-gas is higher than what can be utilized in the syngas producing unit (in the example ca. 13% of off-stream is not utilized as feed). This excess off-gas from the F-T unit is utilized elsewhere in the plant, often as fuel for heating purposes or for power generation. However, this results in additional CO₂ emission within hydrocarbon plant, which can be avoided by utilizing this fraction of off-gas as feed.

### C2

C2 relates to a retrofit of the plant of C1, where an additional fraction of off-gas from the FT-synthesis is utilized as feed to the syngas producing unit (II) comprising autothermal reformer(s). In this example the flow of the recycled off-gas from the F-T unit is increased by 34%. The production of syngas is increased to 105% of the production in C1, i.e. an improved carbon mass balance of the process is obtained.

However, introduction of additional off-gas stream from the F-T as feed to the syngas producing unit (II) has certain challenges in an existing plant. One of the challenges is an increase in O₂ consumption in the syngas-producing unit, i.e. the autothermal reformer, which requires a higher power consumption for an air separation unit (ASU) for generating the O₂. Another challenge is product syngas quality. Syngas product H₂/CO plummets with introduction of additional off-gas stream. Therefore, it is necessary to add H₂ rich stream to the syngas-producing unit (downstream the autothermal reformer(s)) to counteract the effect of additional off-gas feed and maintain required syngas quality. In this case, a feed comprising H₂ from electrolysis is used.

A further challenge is retrofitting of existing autothermal reformer(s). In can be seen that off-gas stream flow is increased by ca. 34% in C2. This may require significant changes in existing unit.

### C3

C3 relates to a process according to the invention and represents an alternative and more suitable approach to revamp the plant cited in C1 by employing a parallel RWGS unit (I) which uses off-gas stream from FT-synthesis section (III) as a sole second feed comprising CO₂ to the RWGS unit (I). The RWGS unit (I) may comprise electrically heated RWGs reactor(s). The production of syngas is increased to 105% of the production in C1, i.e. an improved carbon mass balance of the process is obtained. Also, the process does not generate any excess CO2, which is utilized as fuel for heating purposes, and hence CO2 emission is reduced.

In C3, no additional O₂ is required, since no additional off-gas from the F-T is recycled to the syngas-producing unit (II). Moreover, the requirement of a feed comprising H₂ is reduced to half of that in C2. Lower consumption of fifth feed (5) comprising O₂ and first feed (1) comprising H₂ (as compared to C2) result in lower power consumption for air separation unit (ASU) and electrolysis, respectively. Considering an alkaline electrolysis and a typical ASU, approx. 8% less power consumption relative of product is obtained as compared to C2.

1. A process for producing a hydrocarbon product stream, in a hydrocarbon plant, said hydrocarbon plant comprising:
a reverse water gas shift unit,
a syngas-producing unit,
optionally, a first feed comprising hydrogen to said reverse water gas shift unit,
a second feed comprising carbon dioxide to said reverse water gas shift unit,
a third feed comprising hydrocarbons to said syngas-producing unit,
a Fischer-Tropsch section,
said process comprising the steps of:
a) optionally supplying said first feed comprising hydrogen to said reverse water gas shift unit;
b) supplying said second feed to said reverse water gas shift unit; wherein said second feed is a process off-gas containing less than 75% CO₂ and is the sole carbon dioxide-containing feed to said reverse water gas shift unit, and wherein the process off-gas is a process off-gas from a Fischer-Tropsch unit, a process off-gas from a methanol loop unit, or a combination of two or more off-gases from two or more such units;
c) converting said second feed and—where present—said first feed into a first syngas stream in said reverse water gas shift unit;
d) supplying said third feed comprising methane to said syngas-producing unit and converting it into a second syngas stream;
e) supplying at least a portion of said first syngas stream and at least a portion of said second syngas stream to said Fischer-Tropsch section and converting said portions of said first and second syngas streams into at least a hydrocarbon product stream and an F-T off-gas stream.

2. The process according to claim 1, wherein at least a portion of said F-T off-gas stream from the F-T section is supplied to the RWGS unit as at least a portion of the second feed.

3. The process according to claim 1, wherein at least a portion of said F-T off-gas stream from the F-T section is supplied to the syngas-producing unit.

4. The process according to claim 1, wherein the process off-gas from a methanol loop unit is an off-gas from separator unit of a methanol loop unit or an off-gas from a hydrogen recovery unit of a methanol unit.

5. The process according to claim 1, wherein the process off-gas comprises less than 60% CO₂.

6. The process according to claim 1, wherein the first feed is absent, and wherein the process off-gas is the sole hydrogen-containing feed to said reverse water gas shift unit.

7. The process according to claim 1, wherein the third feed comprising methane comprises at least 20% methane.

8. The process according to claim 1, further comprising combining at least a portion of said first syngas stream and at least a portion of said second syngas stream, and supplying the resulting combined syngas stream to said Fischer-Tropsch section.

9. The process according to claim 1, wherein the RWGS unit is an electrically heated reverse water gas shift unit.

10. The process according to claim 1, wherein the syngas producing unit is selected from the group consisting of an autothermal reforming unit, a partial oxidation unit, a steam methane reforming and an electrically heated steam methane reforming unit.

11. The process according to claim 10 wherein the syngas producing unit is an autothermal reforming unit, and wherein the process further comprises supplying at least a portion of said F-T off-gas stream from the F-T section, a fourth feed comprising steam and a fifth feed comprising oxygen to the autothermal reforming unit.

12. The process according to claim 1, further comprising the step of mixing the first feed comprising hydrogen with the second feed comprising carbon dioxide to provide a combined feed which is provided to the e-RWGS unit.

13. The process according to claim 1, wherein the syngas stream(s) at the inlet of said Fischer-Tropsch section has/have a hydrogen/carbon monoxide ratio in the range 1.00-4.00.
